(19) United States
(12) Patent Application Publication
(10) Pub. No.: US 2026/0175216 A1
(43) Pub. Date: Jun. 25, 2026

(54) SYSTEMS COMPRISING A MICROFLUIDIC DEVICE AND METHODS FOR OBTAINING A SIGNAL

(71) Applicants: FUNDACIÓ INSTITUT DE BIOENGINYERIA DE CATALUNYA, BARCELONA (ES); VITALA TECHNOLOGIES, S.L., TERRASSA (ES)

(72) Inventors: Irene MARCO RIUS, BARCELONA (ES); Maria Alejandra ORTEGA MACHUCA, BARCELONA (ES)

(73) Assignees: FUNDACIÓ INSTITUT DE BIOENGINYERIA DE CATALUNYA, BARCELONA (ES); VITALA TECHNOLOGIES, S.L., TERRASSA (ES)

(21) Appl. No.: 19/124,792

(22) PCT Filed: Oct. 26, 2023
(86) PCT No.: PCT/EP2023/079936

§ 371 Date: Apr. 25, 2025

(30) Foreign Application Priority Data
Oct. 26, 2022 (EP) 22383034.0

(51) Int. Cl. B01L 3/00

(52) U.S. Cl. CPC B01L 3/502715; B01L 3/502753

(57) ABSTRACT

A system including a microfluidic device with a substrate, a non-hyperpolarized isotope label to be introduced, and an apparatus. The substrate of the microfluidic device includes one or more inlet channels, a sample matrix including an analyte, a measuring chamber, and an outlet channel. The non-hyperpolarized isotope label is introduced in an inlet channel so that the non-hyperpolarized isotope label is contacted with the analyte of the sample matrix to form a detection complex. The apparatus obtains a signal of the detection complex. A method of obtaining a signal of the detection complex using a sample matrix is provided.

The present disclosure relates to systems and methods for obtaining a signal of a detection complex.

### BACKGROUND

On the one hand, hyperpolarization-enhanced magnetic resonance techniques, such as Dynamic Nuclear Polarization, are shown to enhance magnetic resonance scans' sensitivity by more than 10,000 times, thereby allowing in-situ metabolomic analysis to be carried out in various types of samples and analytes.

However, hyperpolarization-enhanced magnetic resonance techniques force limited acquisition times to obtain a signal representative of the analyte. Because the polarisation of the hyperpolarized nuclei decays over time, the hyperpolarized nuclei may only be tracked for a limited time (e.g., a few seconds) which greatly limits this magnetic resonance technique as a probe for slower biological processes.

On the other hand, conventional cell culture methods have been valuable for many years since they provided a way to study cell-cell interactions and tissue physiology without using laboratory animals or human subjects. One of the main obstacles that conventional cell culture presents is the morphology and spatial configuration of the cells. To get the cells to survive in the culture, they are seeded in culture vessels (flasks and plates) that are treated to force them to attach to the bottom, changing their morphology and their function for the specific cell type.

### SUMMARY

In one aspect, a system for obtaining a signal is provided. The system includes a microfluidic device with a substrate, a non-hyperpolarized isotope label, and an apparatus. The substrate of the microfluidic device includes one or more inlet channels; a sample matrix including an analyte, a measuring chamber, and an outlet channel. The one or more inlet channels are fluidically connected to the measuring chamber. The measuring chamber is configured to receive the sample matrix including the analyte. The outlet channel is fluidically connected to the measuring chamber. The system further includes a non-hyperpolarized isotope label and an apparatus. The non-hyperpolarized isotope label is to be introduced in the measuring chamber through the inlet channel so that the non-hyperpolarized isotope label is contacted with the analyte of the sample matrix to form a detection complex. The apparatus obtains a signal of the detection complex.

The configuration of the microfluidic device to receive the sample matrix, and the apparatus allow a more standardized and reproducible analysis technique, capable of processing and handling multiple samples of identical or different analytes contacted with a non-hyperpolarized isotope label in a batch-like and in-line manner. Therefore, the measuring chamber may be configured to accommodate the sample matrix containing the analyte, the microfluidic device being structured to infuse the analyte accommodated in the sample matrix with the non-hyperpolarized isotope label.

The sample matrix may increase the cell viability and optimize the metabolic conditions for contacting a non-hyperpolarized isotope label with the analyte to form a detection complex, and subsequently obtain a signal of the detection complex.

Furthermore, the sample matrix may allow adequate distribution of the non-hyperpolarized isotope label through the sample matrix containing the analyte. Therefore, the sample matrix may retain the analyte (under test) and the perfusion of the non-hyperpolarized isotope label which may allow the non-hyperpolarized isotope label to contact the analyte and form the detection complex. As a result, the signal resulting from the detection complex may be obtained with increased reproducibility and improved performance.

In addition, contacting the analyte with the non-hyperpolarized isotope label may allow acquisition times which are not limited by time. As a result, the system may be used for slower biological processes than those detected e.g., with hyperpolarised isotope labels.

In some examples, the system may include a processing unit for determining a state of the analyte based on the obtained signal or a sequence of the obtained signal of the detection complex. Therefore, a versatile platform is created, capable of acquisition of metabolic data pertaining to a state of an analyte using non-hyperpolarized isotope labels and e.g., magnetic resonance techniques or positron emission tomography techniques in a non-invasive manner. For example, with this system, the development of advanced functional person-specific drug testing systems may be achieved.

In some examples, the apparatus to obtain the signal of the detection complex may be a Nuclear Magnetic Resonance (NMR) apparatus or a Positron Emission Tomography (PET) apparatus.

In some examples, the NMR apparatus includes a housing defining a target area for accommodating at least the analyte contacted with the non-hyperpolarized isotope label, a magnet unit and at least one magnetic gradient unit for applying—during use—one or more magnetic field gradients in the target area, and a radiofrequency pulse generation unit for applying one or more sets of radiofrequency pulses towards the target area, and a radiofrequency receiving unit for acquiring signals.

In these examples, the NMR apparatus may be configured to accommodate in the target area the microfluidic device with the sample matrix including the analyte contacted with the non-hyperpolarized isotope label. The sample matrix may be accommodated in the measuring chamber. As a result, reproducibility and repeatability of obtaining NMR signals of an analyte contacted with a non-hyperpolarized isotope label may be improved.

Similarly, the PET apparatus may be configured to accommodate in a target area the microfluidic device with the sample matrix including the analyte contacted with the non-hyperpolarized isotope label. The sample matrix may be accommodated in the measuring chamber. Therefore, reproducibility and repeatability of obtaining PET signals of an analyte contacted with a non-hyperpolarized isotope label may be improved.

In some examples, the microfluidic device may include a temperature control unit for maintaining the analyte contacted with the non-hyperpolarized isotope label (which forms the detection complex) at a body temperature when accommodated in the apparatus (e.g., the NMR apparatus or the PET apparatus). Herewith, measurement conditions mimicking a human or animal body may be achieved and maintained. In some of these examples, the temperature control unit includes a water circulating circuit.

In some examples, to emulate a physiologically cellular micro-environment for the analyte under test, the one or more inlet channels of the microfluidic device may include a non-hyperpolarized isotope label inlet channel for introducing the non-hyperpolarized isotope label, and a matrix perfusion inlet channel for introducing a matrix perfusion medium. In some of these examples, the outlet channel of the microfluidic device may include a measuring chamber outlet channel fluidically connected to the measuring chamber. Therefore, the measuring chamber may be in fluid communication with the non-hyperpolarized isotope label inlet channel; with the matrix perfusion inlet channel; and with the measuring chamber outlet channel. This configuration of the microfluidic device may allow a proper environment for analytes (such as cells). As a result, the measuring chamber may be configured to be a cage incubation enclosure that may maintain a stable environment as to temperature and gas composition and may provide sterile conditions for performing the method of obtaining a signal of the detection complex using the sample matrix. In these examples, the sample matrix including the analyte may be arranged on the measuring chamber.

In these examples, the non-hyperpolarized isotope label inlet channel may be above the matrix perfusion inlet channel with respect to a bottom wall of the measuring chamber.

In some examples, the measuring chamber outlet channel may be below the non-hyperpolarized isotope label inlet channel and above the matrix perfusion inlet channel with respect to the bottom wall of the measuring chamber. In some of these examples, the matrix perfusion inlet channel may be positioned at the bottom wall of the measuring chamber.

Consequently, a continuous flow of matrix perfusion medium (i.e., culture medium) and/or non-hyperpolarized isotope label through the measuring chamber containing the sample matrix including the analyte may be obtained.

In some examples, to establish a standardized and reproducible analysis technique, capable of processing and handling multiple samples of identical or different analytes contacted with the non-hyperpolarized isotope label in a batch-like and in-line manner, the microfluidic device may be provided with multiple measuring chambers, each measuring chamber being in fluid connection with the non-hyperpolarized isotope label inlet channel. Herewith it may be enabled that all measuring chambers containing (a sample matrix with) an analyte receive the same amount of the non-hyperpolarized isotope label.

The sample matrix may be a three-dimensional construct including open pores. In some examples, the three-dimensional construct may include a gel including sodium carboxymethyl cellulose. In some of these examples, the gel may include between 0.5 and 5 wt % of sodium carboxymethyl cellulose, and more specifically 1 wt % of sodium carboxymethyl cellulose.

In these examples, the three-dimensional construct formed from e.g., 1% sodium carboxymethyl cellulose cryogel may serve as a sample matrix for accommodating multiple cells or analytes within the pores of the three-dimensional construct. Such 1% construct may provide a good stability and pore size distribution. Surprisingly, it has been found that 0.5 and 5 wt % of sodium carboxymethyl cellulose, and more specifically 1 wt % of sodium carboxymethyl cellulose has a low affinity for cell attachment and good physical-chemical properties for e.g., NMR applications, PET applications. Therefore, the three-dimensional construct of the sample matrix may provide conditions mimicking a human or animal body, allowing the cells' structure (i.e., the analyte) to live and allowing the cells' structure (i.e., the analyte) to form spheroids (a three-dimensional configuration) and interact with other cells.

In some examples, the three-dimensional construct may be selected from at least one of the following: a ceramic construct, a polymer construct, a metal and/or alloy construct, or a composite construct.

In some of these examples, the three-dimensional construct selected from at least one of the following: a ceramic construct, a polymer construct, a metal and/or alloy construct, or a composite construct may include open pores.

Referring back to the processing unit for determining a state of the analyte based on the obtained signal of the detection complex. The system may be aimed at acquisition and analysis of metabolic data pertaining to a state of an analyte. In order to process such large quantities of data and to provide a more efficient and accurate analysis technique that is less susceptible to noise, the processing unit of the system may be structured to analyse the obtained signals using one or more machine learning models.

In some examples, when the apparatus to obtain the signal of the detection complex is an NMR apparatus, the machine learning model may include a computer-implemented artificial neural network. As a result, the processing unit may include a training unit configured to train the computer-implemented artificial neural network with sequences of NMR signals over time characterizing a training sequence of NMR signals over time with a known state of an analyte contacted with a non-hyperpolarized isotope label, and to apply to the computer-implemented artificial neural network sequences of input signals characterizing at least a test sequence of NMR signals over time with an unknown state of an analyte contacted with a non-hyperpolarized isotope label; and to analyze each applied test sequence of NMR signals over time to generate a predicted state of an analyte contacted with a non-hyperpolarized isotope label for each test sequence of NMR signals over time.

In some examples, during the computer-implemented artificial neural network training, the method may further encompass the outputting of the predicted state of an analyte to verify the accuracy and allow adaptation of the training operations.

Using a trained artificial neural network allows for a proper, correct determination of a predicted state of an analyte. The artificial neural network may be trained on the basis of machine learning techniques, preferably using deep learning techniques. An example of a deep learning technique can be back propagation. The inputted training data used may be magnetic resonance acquired images, annotated by clinical experts showing a state of an analyte (e.g., a cell).

Accordingly, the processing unit may include an output unit configured to output the state of the analyte being determined.

In a further aspect, a method of obtaining a signal of a detection complex using a sample matrix is provided. The method includes providing a microfluidic device with a substrate, and introducing a non-hyperpolarized isotope label.

According to this aspect, the substrate of the microfluidic device includes one or more inlet channels; a sample matrix including an analyte, a measuring chamber, and an outlet channel. The one or more inlet channels are fluidically connected to the measuring chamber. The measuring chamber is configured to receive the sample matrix including the analyte. The outlet channel is fluidically connected to the measuring chamber. Furthermore, the non-hyperpolarized isotope label is to be introduced in the measuring chamber through the inlet channel so that the non-hyperpolarized isotope label is contacted with the analyte of the sample matrix to form a detection complex. As a result, acquisition of metabolic data in a non-invasive manner may be achieved.

In some examples, when the obtained signal of the detection complex is an obtained NMR signal of the detection complex, the method of obtaining the NMR signal of the detection complex may include applying one or more magnetic field gradients to the detection complex using a magnet unit and a magnetic gradient unit of the NMR apparatus; applying one or more sets of radiofrequency pulses to the detection complex using a radiofrequency pulse generation unit of the NMR apparatus; and obtaining from a radiofrequency receiving unit of the NMR apparatus NMR signals or a sequence of NMR signals over time in response to the one or more sets of radiofrequency pulses.

It should be noted that the analyte being provided may be accommodated in a sample matrix emulating a physiologically relevant cellular micro-environment for the analyte under test.

In some examples, the analyte may be positioned in the target area of the NMR apparatus prior to introducing the non-hyperpolarized isotope label in the non-hyperpolarized isotope label inlet channel so that the non-hyperpolarized isotope label is contacted with the analyte of the sample matrix to form the detection complex. As a result, infusing the non-hyperpolarized isotope label into the sample matrix may take place in the NMR apparatus.

In some examples, introducing the non-hyperpolarized isotope label in the non-hyperpolarized isotope label inlet channel so that the non-hyperpolarized isotope label is contacted with the analyte of the sample matrix to form the detection complex may be followed by positioning the microfluidic device in the target area of the NMR apparatus. Therefore, infusing the non-hyperpolarized isotope label into the sample matrix may take place outside the NMR apparatus.

In a similar way, infusing the non-hyperpolarized isotope label into the sample matrix may take place in the PET apparatus or outside the PET apparatus.

In some examples, the method of obtaining a signal of the detection complex using the sample matrix may further include determining a state of the analyte based on the obtained signal or a sequence of the obtained signal of the detection complex. Determining the state of the analyte may be based on a sequence of the obtained signal in some examples.

In some of these examples, when the obtained signal of the detection complex is an obtained NMR signal of the detection complex, the determining of the state of the analyte based on the obtained NMR signal or the sequence of the obtained NMR signal of the detection complex may include generating one or multiple time-frequency representations of the obtained NMR signal or the sequence of the NMR signal by time-frequency transformation; and analyzing the time-frequency representations using one or more machine learning models for determining the state of the analyte.

The time-frequency transformation of the generating one or multiple time-frequency representations of the obtained NMR signal or the sequence of NMR signals may be from at least one of the following: Fourier transform.

The one or more machine learning models may be from at least one of the following: an artificial neural network, a decision tree, a regression model, a k-nearest neighbor model, a partial least squares model, a support vector machine, or an ensemble of the models that are integrated to define a model.

In some examples, the machine learning model may be a computer-implemented artificial neural network, the method may include training the computer-implemented artificial neural network with sequences of NMR signals over time characterizing a training sequence of NMR signals over time with a known state of an analyte contacted with a non-hyperpolarized isotope label; applying to the computer-implemented artificial neural network input signals or sequences of input signals characterizing at least a test sequence of NMR signals overtime with an unknown state of an analyte contacted with an non-hyperpolarized isotope label; and analyzing each applied test sequence of NMR signals over time to generate a predicted state of an analyte contacted with an non-hyperpolarized isotope label for each test sequence of NMR signals over time.

In some examples, the method may include maintaining the detection complex at a body temperature prior to the applying the one or more magnetic field gradients to the detection complex using the magnet unit and the magnetic gradient unit of the NMR apparatus.

For example, the method of the present disclosure may be embodied in a computer program or product, which computer program or product includes computer-coded instructions which, when the computer program or product program is executed by a computer, such as a laptop or a computer, cause the computer to carry out the method disclosed herein.

In some examples, a computer-readable storage medium is proposed including computer-coded instructions stored therein, which computer-coded instructions, when executed by a computer, causes the computer to carry out operations of the computer implemented method disclosed herein. Such computer-readable storage medium can be a (solid-state) hard drive, a USB drive, or a (digital) optical disc.

The term “non-hyperpolarized isotope label” may be used to refer to nuclei that have a spin quantum number above 0 (e.g., 1/2, 1, 3/2, 2, 5/2, 3, 7/2, 9/2). Throughout the disclosure herein, the non-hyperpolarized isotope label may refer to an isotope label which is not hyperpolarized.

In some examples, depending on the apparatus to obtain the signal of the detection complex, the non-hyperpolarized isotope label may be a non-radioactive stable isotope. In some of these examples, the non-hyperpolarized isotope label may be Deuterium ²H. In addition, the non-hyperpolarized isotope label may be selected from at least one of the following: ²H, ⁶Li, ¹⁰B, ¹³C, ¹⁴N, ¹⁵N, ¹⁹F, or ³¹P.

In some examples, the non-hyperpolarized isotope label may be radioactive depending on the apparatus to obtain the signal of the detection complex. An example of radioactive non-hyperpolarized isotope labels may be: ¹¹C, ¹³N, ¹⁵O, or ¹⁸F.

As a result, a radioactive non-hyperpolarized isotope label may contact the analyte to form the detection which may be a PET tracer used in positron emission tomography (PET).

Each PET tracer may include a positron-emitting isotope bound to an organic ligand. For example, a PET tracer may be fluorodeoxyglucose including a ¹⁸F radioactive non-hyperpolarized isotope label bound to e.g., 2-deoxy-2-glucose. The 2-deoxy-2-glucose ligand may be a substrate for an analyte of interest.

In some examples, when the apparatus to obtain the signal of the detection complex is a PET apparatus, the PET apparatus may include radiation detectors (i.e., scintillators), a photomultiplier, and read-out electronics.

The radioactive non-hyperpolarized isotope label may be a β+ radioactive atom including a short decay time, e.g., ¹¹C, ¹³N, ¹⁵O, or ¹⁸F. During decay of the nuclei of the radioactive non-hyperpolarized isotope labels, positrons may be emitted. Men a positron is emitted and contacts an electron, the contact may produce gamma rays. The produced gamma rays may be detected by scintillators which may convert the gamma rays to photons of light that are transmitted to the photomultiplier which may convert the photons to electrical signals. These electrical signals may be processed by a processing unit to generate three dimensional images of the analyte. As a result, PET apparatuses may produce images of an analyte by detecting radiation emitted from the radioactive non-hyperpolarized isotope labels contacted with the analyte.

The term “analyte” may be used to refer to healthy and diseased cells of human or animal organs and tissues, human or animal cells (or cell fragments), organoids, corporal fluids from humans or animals and whole animals as well as cells and fluids from vegetables. It may be understood that by animals, we may refer to animals such as but not limited to human beings, but also animal beings, such as rats, rabbits, pigs, and mice.

The term “state” may be used to refer to a physiological condition, e.g., the health or unhealth (or disease) states as well as any transition state from health to unhealth (or disease) of the target/analyte; or the health or unhealth (or disease) states as well as any transition state from health to unhealth (or disease) of the whole human or animal being or of the human or animal being from whom those targets or analytes were taken.

The term “wt %” may be used to refer to a weight percentage of a first component (e.g., sodium carboxymethyl cellulose) relative to the total weight of a second component (e.g., the sample matrix).

### BRIEF DESCRIPTION OF THE DRAWINGS

Non-limiting examples of the present disclosure will be described in the following, with reference to the appended drawings, in which:

FIGS. 1a-1b are an example of a system according to the disclosure hereof implementing an example of a method according to the disclosure hereof;

FIGS. 2-6 provide details of several components of the system according to the disclosure hereof.

### DETAILED DESCRIPTION OF EXAMPLES

For a proper understanding of the disclosure, in the detailed description below corresponding elements or parts of the disclosure will be denoted with identical reference numerals in the drawings.

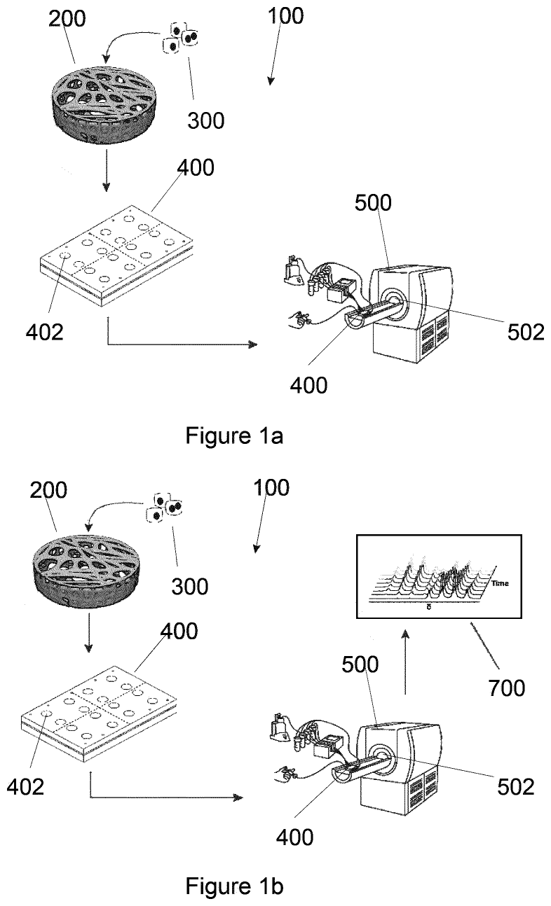

In FIGS. 1a and 1b, a first example and a second example of a system according to the present disclosure is shown. The example of FIG. 1a or FIG. 1b is schematic and not to scale, and the main components of the system are shown in their interrelation functionality. Each component will be discussed in more detail and in more variation in relation to other figures.

The system according to the present disclosure, for obtaining a signal of a detection complex using a sample matrix in at least one analyte contacted with a non-hyperpolarized isotope label and nuclear magnetic resonance is denoted with reference numeral 100. FIG. 1a represents the system 100 including: a sample matrix 200 containing an analyte 300; a microfluidic device 400 provided with at least one measuring chamber 402 structured to accommodate a sample matrix 200 containing the analyte 300; the microfluidic device contacts a non-hyperpolarized isotope label 600 with the analyte of the sample matrix to form a detection complex; and an apparatus 500 to obtain a signal of the detection complex. In this example, the apparatus 500 includes a housing defining a target area 502 for accommodating at least the analyte 300 with the non-hyperpolarized isotope label 600.

Throughout the present disclosure the apparatus 500 to obtain the signal of the detection complex may be, for example, an NMR apparatus or a PET apparatus. Depending on the application and the non-hyperpolarized isotope label, an NMR apparatus or a PET apparatus may be used to obtain a signal (NMR signal or PET signal) of the detection complex.

The apparatus 500 may be an apparatus suitable for obtaining a signal of the detection complex which includes the non-hyperpolarized isotope label and the analyte.

In FIG. 1b, the system 100 further includes a processing unit 700 for determining a state of the analyte 300 by analysing a sequence of the obtained signals.

In the next paragraphs of the description, the system 100 will be described in more detail.

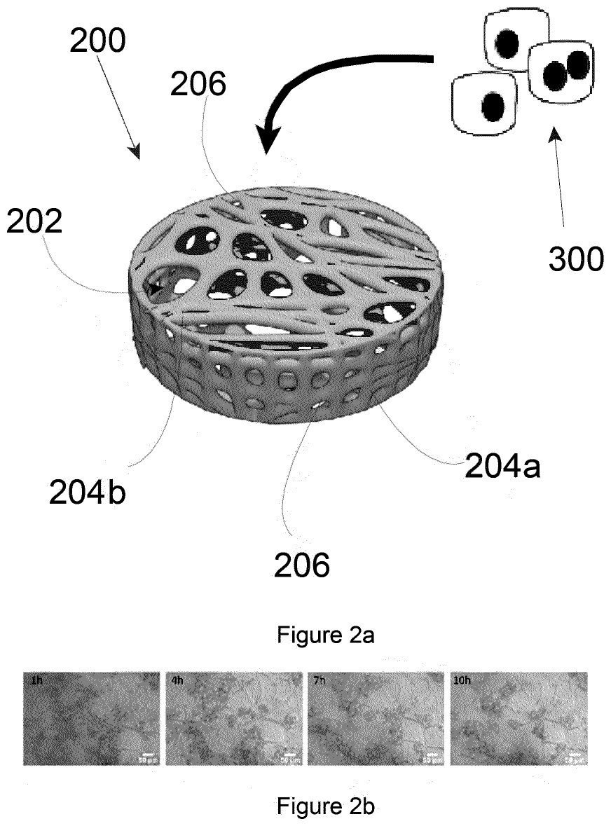

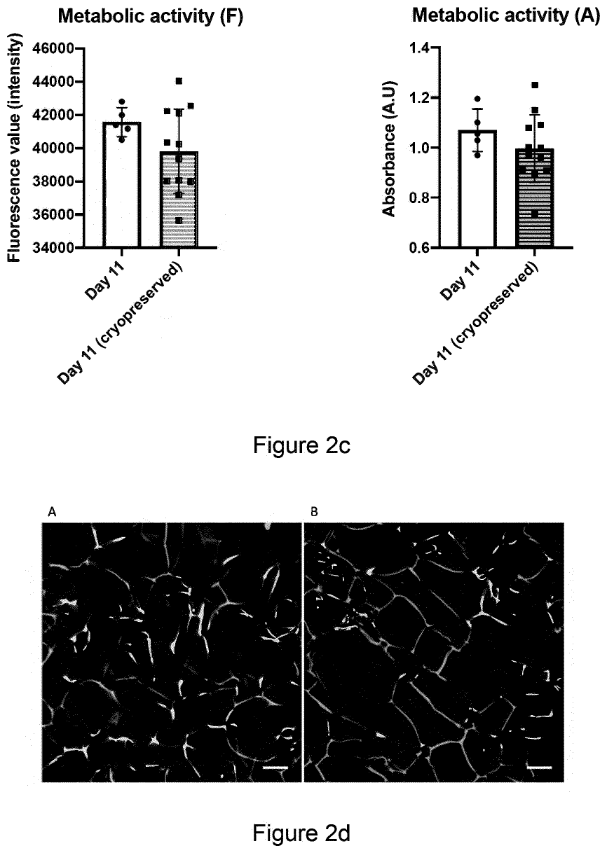

FIG. 2a depicts an advantageous alternative for the conventional cell culture methods as they have been used for many years. Also, with this alternative, an effective way to study cell-cell interactions and tissue physiology is feasible without using laboratory animals or human subjects. One of the main obstacles that conventional cell culture presents is the morphology and spatial configuration of the cells. To get the cells (or analytes in this description) to survive in the culture, they are seeded in culture vessels (flasks and plates) that are treated to force them to attach to the bottom, changing their morphology and their function for the specific cell type.

Reference numeral 200 in FIG. 2a denotes a sample matrix for accommodating one or more analytes or cells (denoted with reference numeral 300 throughout the description herein) in a three-dimensional configuration for in vitro analysis. According to the present disclosure, the sample matrix 200 is formed as a three-dimensional construct in this example. The three-dimensional construct of the sample matrix 200 envelops a space 202 in which a cluster of individual analytes or cells 300 are accommodated.

As shown in FIG. 2a the three-dimensional construct of the sample matrix, 200 is formed from a gel constituting a mesh or a criss-cross lattice pattern of interconnecting gel strands 204a-204b with open pores 206 in between. The open pores 206 are of an irregular shape and size distribution.

The gel of the open, three-dimensional construct of the sample matrix 200 at least includes sodium carboxymethyl cellulose and specifically at least includes 0.5-5% (wt.) sodium carboxymethyl cellulose, and in some more specific examples 1% (wt.) sodium carboxymethyl cellulose.

The following method operations describe in detail each operation required for the proper synthesis of 1% carboxymethyl cellulose gel. As basic, starting ingredients for fabrication, the 1% carboxymethyl cellulose gel are used:
Sodium carboxymethyl-cellulose (CMC) [419273, Sigma]
Adipic acid dihydrazide (AAD) [MW.=174.2 g/mol]
Morpholino-ethane-sulfonic acid (MES) [MW.=195.2 g/mol], and
N-(3-Dimethylaminopropyl)-N′-ethylcarbodiimide hydrochloride (EDC) [E7750-10g, Sigma]

In a first operation, a MES buffer having a pH 5.5 and 0.5 M is prepared. For 100 ml, the operations are:
1. Prepare 80 ml of distilled H₂O in a container
2. Add 9.76 g of MES free acid to the 80 ml of distilled H₂O solution
3. Adjust the solution to a pH 5.5 using NaOH. For 100 ml, it may be required to add 366 mg of NaOH (solid) or 9.15 ml of NaOH 1 M to the distilled H₂O solution.
4. Add additional distilled H₂O until the volume of the solution has reached 100 ml.

In detail:

| MES | NaOH | distilled H₂O |
|---|---|---|
| 9-76 g | 366 mg | Adjust to 100 ml |

5. Subsequently, store the solution obtained in operation 4 at 4° C.

Next, a polymer premix is prepared (1.1 ml):
6. CMC 1% (w/v) is provided, and 50 mg thereof is dissolved in 5 ml of distilled H₂O, using stirring (e.g., with a magnetic stirrer at 900 rpm)
7.100 μL of AAD (50 mg/ml) is added to 1 ml of the CMC 1% solution and mixed by pipetting.
8. This premix is pre-cooled at 4° C.
9.4 mg of EDC is dissolved in 4 μl of distilled H₂O, thus preparing EDC (1 mg/μl).
10. The EDC is added to the premix, and the homogeneity of the solution is ensured by pipetting.

In detail:

| CMC 10 mg/mL | | | EDC |
|---|---|---|---|
| (1%) | MES pH 5.5, 0.5M | d-H₂O | (1 mg/mL) |
| 1 mL | 100 mL | 7 mL | 4 mL |

11. Next, transfer the gel is transferred rather quickly to the mould and incubated.

In the event that the mould has a large volume, the mould is pre-cooled in a freezer at −20° C. before the gel is added, thus:
12. Incubate at −20° C. The mould containing the gel is to be placed in a freezer for 24 hours. After that time, the cryogel is to be removed carefully from the mould.

For example, an open, three-dimensional construct may be formed from 1% CMC cryogel, which construct may serve as a sample matrix 200 for accommodating multiple cells or analytes within the open, inner space 202. Such 1% construct may provide a good stability and pore size distribution.

Surprisingly, it has been found that 0.5 and 5 wt % of sodium carboxymethyl cellulose, and more specifically 1 wt % of sodium carboxymethyl cellulose has a low affinity for cell attachment and good physical-chemical properties for NMR applications or PET applications. Therefore, the three-dimensional construct of the sample matrix 200 may provide conditions mimicking a human or animal body, allowing the cells' structure (i.e., the analyte) to live and allowing the cells' structure (i.e., the analyte) to form spheroids (a three-dimensional configuration) and interact with each other instead of the gel material.

An example of a sample matrix 200 obtained with the preparation technique described above may have a diameter of 5 mm and a height of 2 mm. More specifically, the dimensions of the sample matrix 200 may be in the range of 3-10 mm in diameter and in the range of 1-6 mm in height, depending on the intended application.

The sample matrix 200 increases the cell viability and optimizes the metabolic conditions required to study, for example, hepatocyte metabolism. In an example, as depicted in FIG. 2b, AML12 cell line was used, including non-cancerous mouse hepatocytes, to study cell aging under laboratory conditions. It was observed that 13 h after seeding the cells 300 in the cryogel sample matrix 200, the formation of spheroids could already be observed. The open, three-dimensional construct of the sample matrix 200 ascertains that cells 300 are retained inside the inner space 202 by the interconnecting cryogel strands 204a-204b with open pores 206 between them, and cells 300 aggregate on their own.

In addition, it should be mentioned that the sample matrix 200 made from the CMC material as disclosed above, does not interfere during the signal acquisition (e.g., NMR signal or PET signal) and allows the correct perfusion of the non-hyperpolarized isotope label 600.

In FIG. 2b, the cryogels may be seeded with a million cells and placed inside a microscope for longitudinal imaging. Spheroid formation may be observed starting three hours after cell seeding and up to 10 hours later.

Cryopreservation of cells has traditionally been done in cell suspension. With this known technique, cells would be cultured in a 2D system until they are stress-free and before they cover the bottom of the flask in which they are cultured. Usually, the cells are poured into a freezing media (e.g., containing serum and DMSO as a cryopreservant) of, for example, −80° C. Some 12 24 hours later, the pre-cooled cells would be moved to the nitrogen tank for preservation. When thawed, the cells are cultured back in 2D conditions. However, this process requires 3-4 days before the cells can be used in experimental set-ups.

In order to explore the possibility of preservation of multiple 3D sample matrix′ 200 containing the analyte 300 previous to the diffusion with the non-hyperpolarized isotope label 600 and measuring with the apparatus 500; the 3D sample matrix 200 containing the analyte is structured to be frozen sub-zero temperatures and to be kept at that temperature for several days. Surprisingly, the 3D sample matrix 200 containing the analyte 300 is able to maintain the analyte 300 in good condition even after a defrost cycle without affecting or damaging the analyte 300. Viability and metabolic assays confirm that the analyte remain functional after a defrost process without requiring a cell culturing room or incubator to use the system.

As an example of the functionality of the sample matrix 200 according to the disclosure for maintaining the analyte 300 in good condition even after a defrost cycle and without affecting or damaging the analyte, FIG. 2c depicts metabolic results obtained from an Alamar Blue test showing that cells remain alive inside the cryogel construct after cryopreserving them inside the construct for a period up to 11 days with similar viability to those that did not undergo the cryopreservation process. The results are shown both in fluorescence and absorbance readings for the Alamar Blue test, two outputs from the same metabolic test.

Furthermore, FIG. 2d shows (with a scalebar of 100 μm) in two confocal microscopy images A and B of the inner side of the cryogels the structural integrity before and after undergoing cryopreservation. FIG. 2dA (left) shows the cryogel of the sample matrix 200 imaged before the cryopreservation process, whereas FIG. 2dB (right) shows the cryogel of the sample matrix 200 imaged after the cryopreservation process. As it may be observed, no damage to the cryogel strands 204a-204b has occurred during the cryopreservation, thus conserving the structural integrity of the 3D, open construct of the sample matrix 200.

The results of FIGS. 2c and 2d show evidence that cells/analytes 300 may be seeded in a cryogel construct as depicted in FIG. 2a and cryopreserved in liquid nitrogen after 24 hours. The tests show a high viability up to 11 days post-thawing, compared to results of cryogels that did not undergo cryopreservation. Additionally, the cryogel construct can sustain the cryopreservation process after seeding of cells/analytes 300, keeping their structural integrity, which is essential for undergoing the subsequent infusion with the non-hyperpolarized isotope label 600, and the data acquisition with the apparatus 500.

In some examples, the sample matrix which is a three-dimensional construct may be selected from at least one of the following: a ceramic construct, a polymer construct, a metal and/or alloy construct, or a composite construct. In these examples, the sample matrix may be suitable for seeding the analyte 300 within the sample matrix while allowing contact of the seeded analyte with the non-hyperpolarized isotope label to form the detection complex.

In some of these examples, the three-dimensional construct selected from at least one of the following: a ceramic construct, a polymer construct, a metal and/or alloy construct, or a composite construct may include open pores.

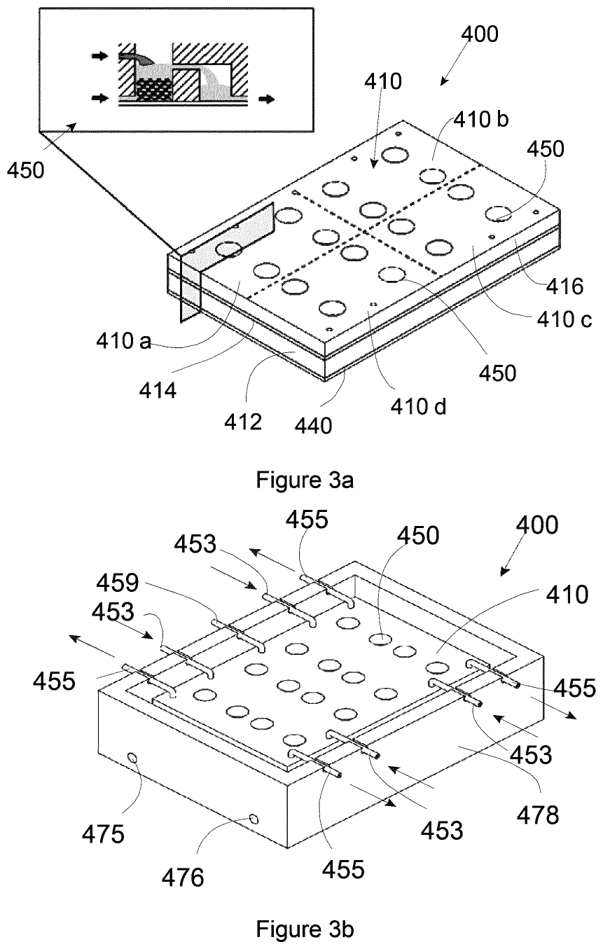

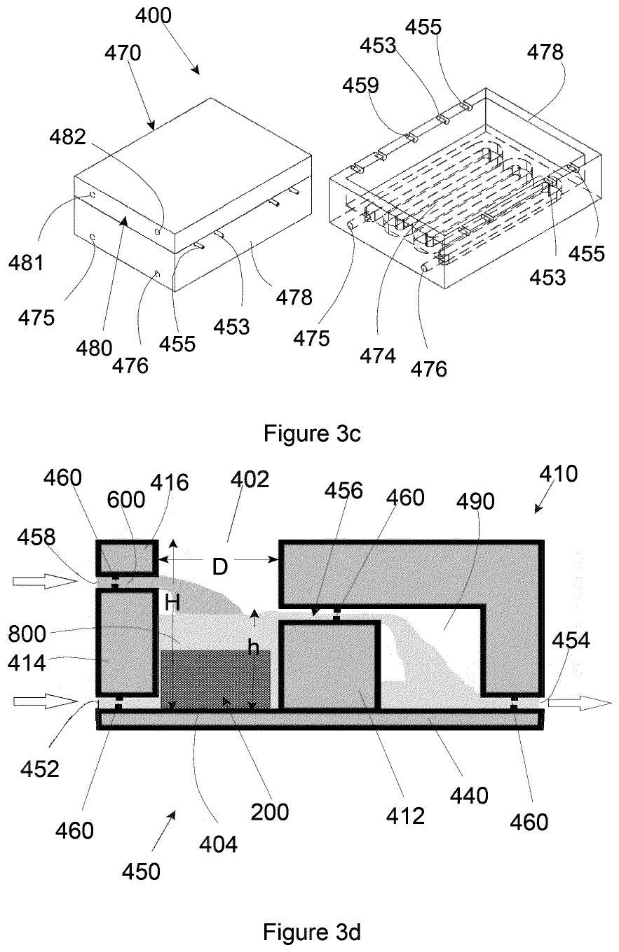

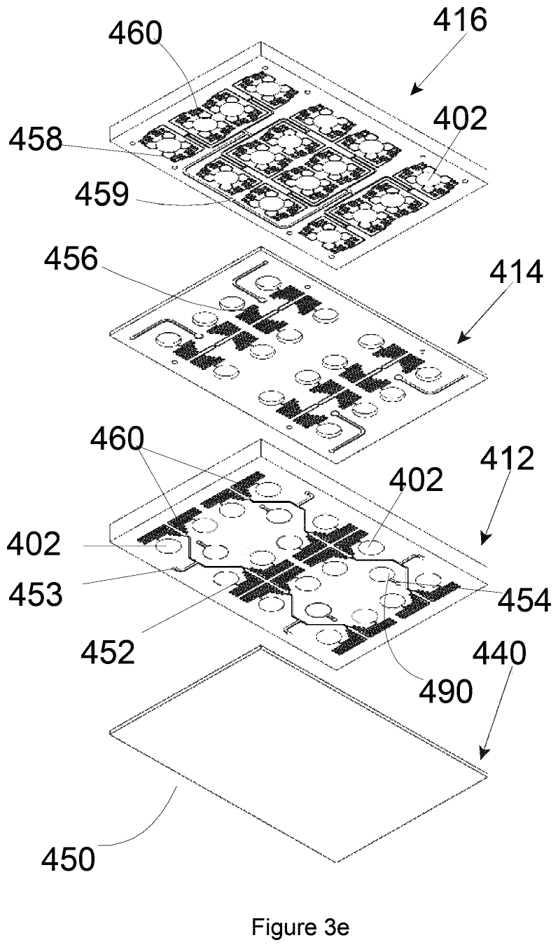

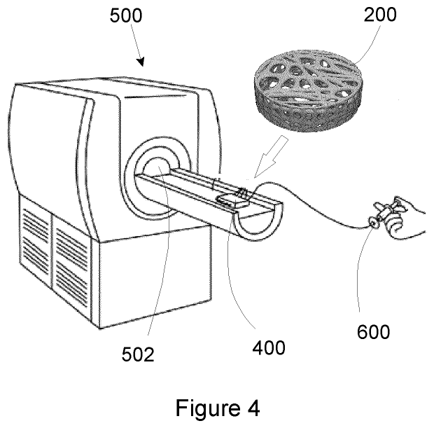

FIGS. 3a and 3b depict in more detail a further component of the system according to the disclosure.

Reference numeral 400 denotes the component of the system being a microfluidic device. In some examples, the microfluidic device 400 includes substrate structures, denoted with reference numerals 410, 420, and 430. Substrate structures 410, 420, and 430 may be a stack of layers (e.g., a stack of 2 layers). Reference numeral 410 represents a substrate structure composed of multiple (e.g., three) polydimethylsiloxanes (PDMS) layers, for example, a first PDMS layer 412, a second PDMS layer 414, and a third PDMS layer 416. In these examples, the PDMS layers (e.g., the first PDMS layer 412, the second PDMS layer 414, and the third PDMS layer 416) are deposited on a glass slide 440. A typical and suitable dimension of the glass slide is 75×50 mm. This can be changed to accommodate the dimensions of the NMR apparatus 500.

FIG. 3b details the microfluidic device 400 in more detail and in particular details one single microfluidic element 450, mounted on the substrate structure 410. Preferably, the microfluidic device 400 includes a plurality of such microfluidic elements 450, each being provided such well or the measuring chamber 402 for individually accommodating the sample matrix 200 including the analyte 300.

As shown in FIG. 3a, the substrate structure 410 includes several quadrants or sets 410a, 410b, 410c, 410d (here four sets). Each set 410a, 410b, 410c, 410d is composed of microfluidic elements 450 of identical configuration, here four. In FIG. 3a, the configuration of the substrate structure 410 is composed of 4×4 (16) microfluidic elements 450. In the example, each microfluidic element 450 includes a well/measuring chamber 402 with dimensions of 6 mm in diameter D and 10 mm in height H, see FIG. 3d.

Each microfluidic element 450 includes a matrix perfusion inlet channel 452 and a microfluidic outlet channel 454, which are in fluid communication with the well or measuring chamber 402. The matrix perfusion inlet channel 452 is for supplying a matrix perfusion medium 800 to the measuring chamber 402 so that the matrix perfusion medium 800 is contacted with the sample matrix. The matrix perfusion inlet channel 452 and the microfluidic outlet channel 454 may be provided within the second PDMS layer 414 (e.g., of 5 mm thick) of the substrate structure 410 on the glass slide 440.

The microfluidic element 450 includes a measuring chamber outlet channel 456, which functions as the measurement chamber exit line. The measuring chamber outlet channel 456 may be provided within the second PDMS layer 414 (e.g., of 1 mm thick).

The microfluidic element 450 includes a non-hyperpolarized isotope label inlet channel 458 for supplying the non-hyperpolarized isotope label 600 to the measuring chamber 402. The non-hyperpolarized isotope label inlet channel 458 may be provided in the third PDMS layer 416 (e.g., of 4 mm thick).

In some examples, the PDMS layers 412, 414 and 416 are manufactured by replica moulding using SU-8 microstructures produced by photolithography on 4-inch sized silicon wafers. The silicon substrates were dehydrated using a hot plate at 200° C. for 30 minutes and afterwards cleaned/activated using an O₂ plasma (PDC-002, Harrick Plasma, Ithaca, NY, USA) treatment at 22.5 ml/min and 30 W for 20 minutes. A photoresist material (SU-8 2100, KAYAKU Advanced Materials, Inc., Westborough, MA, USA) was spin-coated to form a SU-8 layer of 200 μm thickness. Also, PDMS prepolymer was prepared in a ratio of 10:1 (base: curing agent, w/w) and degassed in a vacuum desiccator. The prepolymer was then cast on a Petri dish containing the SU-8 mould, backed at 65° C. for four hours, and subsequently left overnight at room temperature. The three PDMS layers together with the glass slide were activated using O₂ plasma and bonded together, resulting in a 11 mm thick device.

As shown in detail in FIG. 3d, for each microfluidic element 450 of the microfluidic device 400, the non-hyperpolarized isotope label inlet channel 458 is positioned at a position above a position of the matrix perfusion inlet channel 452 with respect to the bottom wall 404 of the well/measuring chamber 402. Similarly, the measuring chamber outlet channel 456 is positioned at a position lower than that of the non-hyperpolarized isotope label inlet channel 458 and at a position higher than that of the matrix perfusion inlet channel 452 with respect to the bottom wall 404 of the measuring chamber 402. In this example, the matrix perfusion inlet channel 452 is positioned at the bottom wall 404 of the measuring chamber 402 and accordingly flushes—during use—the open, porous sample matrix 200 with analytes 300 from the bottom side towards the upper side towards the measuring chamber outlet channel 456.

Accordingly, a continuous flow of matrix perfusion medium 800 (culture medium) through the measuring chamber 402 is allowed as well as the injection of the non-hyperpolarized isotope label 600 for the analyte to be analysed. Due to the specific height configuration of the channels 452, 456, and 458, the measuring chamber outlet channel 456 withdraws the matrix perfusion medium 800 from the respective well/measuring chamber 402 whilst keeping a constant liquid height h from the bottom wall 404 of the well 402. Accordingly, during use, this accounts for ˜140 μl of total medium volume per well 402.

In the example of the microfluidic device 400 four groups of four microfluidic elements 450 (each with a well/measuring chamber 402) allow for analysing up to sixteen biological samples. As the microfluidic elements 450 are grouped in four independent sets 410a, 410b, 410c, 410d of four wells 402, each set of four wells/measuring chambers 402 share the culture media 800 via a central matrix perfusion inlet channel 453 and a central matrix perfusion outlet channel 455.

In FIG. 3b, microfluidic resistances 460 are schematically depicted in the microfluidic channels 452, 454, 456, and 458 of each microfluidic element 450. Although FIG. 3b depicts these microfluidic resistances 460 being positioned in each microfluidic channels 452, 454, 456, and 458, it is sufficient to include a microfluidic resistance 460 in at least one of the matrix perfusion inlet channel 452 and the outlet channel (either the microfluidic outlet channel 454 or the measuring chamber outlet channel 456). See also FIG. 3e showing in more detail the microfluidic resistances 460 structured as serpentines.

Microfluidic resistances 460 at the matrix perfusion inlet channel 452 and the outlet channel (either the microfluidic outlet channel 454 or the measuring chamber outlet channel 456) of the well/measuring chamber 402 enable the same flow rate through each well/measuring chamber 402 containing the 3D sample matrix 200 with the analyte 300. Furthermore, all the wells/measuring chambers 402 of a set 410a, 410b, 410c, 410d are connected to an embedded suction reservoir 490 that withdraws the matrix perfusion medium 800. In another example, microfluidic resistances 460 can be placed in each central matrix perfusion inlet channel 453 and central matrix perfusion outlet channel 455 belonging to each set 410a, 410b, 410c, 410d of microfluidic elements 450.

Since the non-hyperpolarized isotope label inlet channel 458 is positioned at a position above a position of both the matrix perfusion inlet channel 452 as well as the measuring chamber outlet channel 456 with respect to the bottom wall 404 of the well/measuring chamber 402, the non-hyperpolarized isotope label inlet channel 458 is able to distribute the non-hyperpolarized isotope label 600 to all the wells/measuring chambers 402 belonging to the same set 410a, 410b, 410c, 410d. Therefore, isolation between the sets 410a, 410b, 410c, 410d is maintained, allowing the sets 410a, 410b, 410c, 410d each to be infused with the non-hyperpolarized isotope label 600, allowing more diverse and versatile analysis.

In FIG. 3d, the microfluidic outlet channel 454 is fluidically connected to the reservoir 490. In this example, the reservoir 490 is fluidically connected to the measuring chamber outlet channel 456.

In some examples, the microfluidic element 450 may not include the reservoir 490 and include only the measuring chamber outlet channel as the outlet channel of the microfluidic device 400.

A proper environment for the analyte 300 may be created by accommodating the microfluidic device 400 in an incubation enclosure 470. The incubation enclosure 470 may maintain stable temperature and gases (O₂ and CO₂) as well as sterile conditions while the microfluidic device 450 is handled by operational personnel into the NMR apparatus 500.

In some examples, the microfluidic device 400 may include in its incubation enclosure 470, a temperature control unit 472. The temperature control unit 472 may serve to maintain each microfluidic element 450, and accordingly the assembly composed by the 3D sample matrix containing the analyte 300, with the non-hyperpolarized isotope label 600 at a body temperature. In these examples, the system 100 may include the temperature control unit 472 when the microfluidic device 400 with the microfluidic elements 450 may be accommodated in the apparatus 500. Herewith, measurement conditions mimicking a human or animal body may be achieved and maintained. In some examples, the temperature control unit 472 may include a water circulating circuit 474 with a water inlet 475 and a water outlet 476.

The temperature inside the incubation enclosure 470 may be controlled by pumping warm water from a water bath into the enclosure base 478 that acts as a water jacket. Otherwise, the enclosure lid 480 has inlet 481 and outlet 482 to achieve a stable gas incubation.

For proper use of the system and method according to the present disclosure, sample matrices 200 as described e.g., in the paragraphs relating to FIGS. 2a-2b provided with the analyte 300 within the open, porous space 202 are each placed within a well/measuring chamber 402 of each microfluidic element 450 of the microfluidic device 400. Subsequently, the fluidic system includes several microfluidic channels 452, 454, 456, 458 which allow the continuous flow of culture media 800 through each well/measuring chamber 402, thereby perfusing each sample matrix 200 with the analytes 300 contained therein.

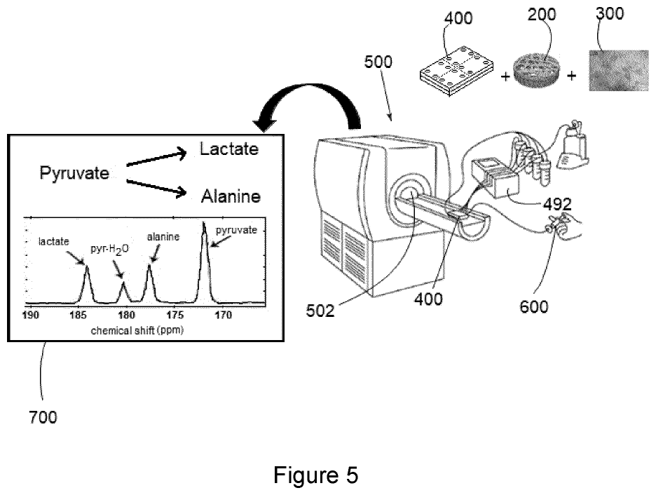

The fluidic system may include the reservoir 490 connected to a vacuum pump and a peristaltic pump (both indicated with reference numeral 492 in FIG. 5). This set-up may be replicated for all four sets 410a, 410b, 410c, 410d. The peristaltic pump 492 flows the matrix perfusion medium 800 (culture medium) from and to the reservoir 490 to each well/measuring chamber 402 of the microfluidic element 450 (of the microfluidic device 400) in a reciprocating manner, thus perfusing the sample matrix 200 and the analyte 300. The vacuum pump 492 may apply a negative pressure at reservoir 490, and the matrix perfusion medium 800 (culture medium) is sucked out from the microfluidic element 450 via the outlet channel (e.g., the microfluidic outlet channel 454 or the measuring chamber outlet channel 456).

For performing the non-hyperpolarized isotope label-measurement (e.g., NMR or PET measurement), the peristaltic pump is interrupted, and an amount of non-hyperpolarized isotope label 600 is injected into the central non-hyperpolarized isotope label inlet channel 459. The central non-hyperpolarized isotope label inlet channel 459 splits the specific amount of non-hyperpolarized isotope label 600 into smaller samples, the number of smaller samples of non-hyperpolarized isotope label 600 being conformal to the number of microfluidic elements 450 of the sets 410a, 410b, 410c, 410d.

In this example, the specific central non-hyperpolarized isotope label inlet channel 459 is in fluid communication with each well/measuring chamber 402 of the microfluidic elements 450. This configuration enables all the wells 402 containing a sample matrix 200 with analytes/cells 300 to receive the same non-hyperpolarized isotope label sample volume. For instance, the non-hyperpolarized isotope label sample volume may be of 100 μL with a concentration included between 1 μM and 1000 mM, specifically between 10 μM and 500 mM, and more specifically between 10 μM and 300 mM of non-hyperpolarized isotope label. The non-hyperpolarized isotope label sample volume of e.g., 100 μL (mentioned above) may be delivered per well/measuring chamber 402 of a microfluidic element 450 during a predetermined time (e.g., seconds) depending on the configuration of the microfluidic device 400 and/or an injection device.

In some examples, the injection of the non-hyperpolarized isotope label may be performed via e.g., bolus injection (which may lead to high concentrations of non-hyperpolarized isotope label within seconds), or a continuous infusion of sample volume (which may lead to lower concentrations of non-hyperpolarized isotope label for over minutes to hours).

Because of the porous and/or the sample matrix fabrication methodology, the open, three-dimensional construct of the sample matrix 200 exhibits a high permeability and may permit an adequate and/or rapid distribution of the non-hyperpolarized isotope label 600 through the 3D sample matrix 200 containing the analyte 300.

Therefore, the non-hyperpolarized isotope label 600 may be inserted into the microfluidic device 400.

The non-hyperpolarized isotope label 600 is injected into the microfluidic device 400 including at least one 3D sample matrix 200 with the analyte 300 to be analysed. The microfluidic device 400 with the at least one 3D sample matrix 200 accommodated in a measuring chamber 402, with the at least one 3D sample matrix 200 containing the analyte 300 with an amount of the non-hyperpolarized isotope label 600 being injected, is subsequently placed into the NMR apparatus 500, where the signal (e.g., NMR signal or PET signal) is then acquired.

In some examples, the microfluidic device 400 with the at least one 3D sample matrix 200 accommodated in the measuring chamber 402 and containing the analyte 300 is placed into the apparatus 500 (e.g., NMR apparatus or PET apparatus) and subsequently the amount of the non-hyperpolarized isotope label 600 may be injected into the microfluidic device 400 thereby infusing the analyte 300 to be analysed.

As depicted in FIG. 5, the apparatus 500 (e.g., NMR apparatus or PET apparatus) is structured to accommodate in its target area 502, the microfluidic device 400 with one or more sample matrices 200 each containing the analyte 300 infused with the non-hyperpolarized isotope label 600 accommodated in the associated measuring chamber 402. The system 100 is structured to determine a state in only one sample of analyte 300 (in fact, a large amount of a specific type of cells or analytes 300) with non-hyperpolarized isotope label 600.

The signal of the detection complex may be obtained if the detection complex is formed and located in the target area 502 of the device (e.g., NMR apparatus or PET apparatus).

In practice, the microfluidic device 400 as described in relation to FIGS. 3a and 3b has multiple (e.g., 4×4) microfluidic elements 450, each structured to accommodate a 3D sample matrix with cells or analytes 300 infused with an amount of non-hyperpolarized isotope label 600 to be analysed in their associated measuring chamber 402. Thus, this allows for a more standardized and reproducible analysis technique, capable of processing and handling multiple samples of identical or different analytes 300 using the same amount of non-hyperpolarized isotope label 600 simultaneously and in a batch-like and in-line manner.

The apparatus 500, when the apparatus to obtain a signal of the detection complex is a NMR apparatus, also accommodates a magnet unit and a magnetic gradient unit (not depicted) for applying—during use—one or more magnetic field gradients Bo in the target area 502, to the detection complex. The NMR apparatus furthermore includes in its housing a radiofrequency pulse generation unit for applying one or more sets of radiofrequency pulses towards the target area 502 to the detection complex including the one or multiple amounts of non-hyperpolarized isotope label 600 with cells or analytes 300.

In order to obtain spectroscopic information from all samples (one or multiple amounts of cells or analytes 300 infused with the non-hyperpolarized isotope label 600) accommodated in the 3D sample matrix 200 in the measuring chambers 402 of the several microfluidic elements 450 of the microfluidic device 400 simultaneously, radiofrequency pulse sequences are generated by a radiofrequency pulse generation unit and applied. These radiofrequency pulse sequences provide spatially localized spectral information in a time-window of data acquisition.

The time-sequence set of NMR signals thus generated in the target area are picked up using a radiofrequency coil of the radiofrequency receiving unit of the NMR apparatus. The radiofrequency coil converts the change in the magnetic field in the target area 502 as induced by the nuclei's precession in the analytes 300 into electromagnetic current signals and transferred to the processing unit 700. The computer processing unit 700 analyses the sequence of the obtained NMR signals 510 and, based on the analysis, determines the state of the analyte 300.

Once the data-acquisition after the NMR measuring has been performed, the perfusion system starts again.

It may be noted that data-acquisition after the PET measuring may be performed in an analogue way to what is described above.

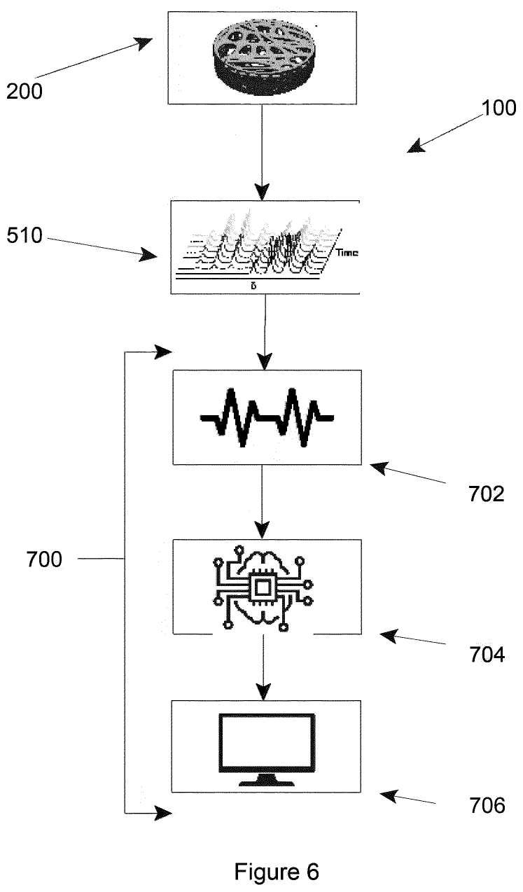

As outlined in FIG. 6, the processing unit 700 is structured to analyse the obtained signal or at least the sequence of the obtained NMR signals 510 from the NMR apparatus using one or more machine learning models. Accordingly, the processing unit 700 implements a data transformation unit 702, which is structured to acquire from the NMR apparatus the obtained signal or the sequence of the obtained NMR signals 510 as converted in time-dependent electromagnetic current signals. The data transformation unit 702 may be linked to the NMR apparatus using suitable signal wiring for receiving the data stream of time-sequence sets of NMR signals, or through a wireless data-communication interface operating in accordance with a network protocol for exchanging data, such as designated ZigBee™, Bluetooth™, or Wi-Fi based protocols for wireless networks.

In an operation of the computer-implemented method according to the present disclosure, the processing unit 700 amplifies and stores time-sequence sets of NMR signals as intensity vs. time (time-domain signal-free induction decay, FID). For this purpose, the processing unit 700 utilizes the data transformation unit 702, which implements at least one time-frequency transformation model for generating one or multiple time-frequency representations of the time-sequence set of NMR signals. In spectroscopic experiments, the NMR signal is zero-filled, Fourier Transformed, and the baseline-corrected. The area under the curve of each peak in the spectrum is calculated, and correction factors may be applied for flip angle or other acquisition particularities. In some examples, pulse sequences may require deconvolution of the signal (e.g., SPEN).

The time-frequency transformation of the time-sequence set of NMR signals may be selected from at least one of the following: short-time Fourier transform, wavelet transform, filter bank, or discrete cosine transform.

The processing unit 700 is structured to analyse the time-frequency representations of the time-sequence set of NMR signals using one or more machine learning models in order to determine the state of the analyte 300. For illustrative purposes, the one or more machine learning models is denoted with reference numeral 704 in FIG. 6. In an example, the processing unit 700 may implement a model processing unit 704 incorporating a computer-readable storage unit (not shown) including computer-coded instructions stored therein, which computer-coded instructions, when executed, perform the machine learning model.

The storage unit of the computer processing unit 700 can be a hard disc unit or a solid-state storage unit, or a removable storage device such as a USB storage unit mounted in a laptop or computer implementing computer code performing the computer-implemented method according to the disclosure.

According to the disclosure, the computer processing unit 700 can be (part of) a laptop or computer, which may be implementing computer code performing the computer-implemented method according to the disclosure. For example, the method of the present disclosure can be embodied in a computer program or product, which computer program or product includes computer-coded instructions which, when the computer program or product program is executed by a computer, such as a laptop or a computer, cause the computer to carry out operations of the computer implemented method disclosed herein.

In some examples, a computer-readable storage medium is proposed including computer-coded instructions stored therein, which computer-coded instructions, when executed by a computer, cause the computer to carry out operations of the computer implemented method disclosed in this specification. Such computer-readable storage medium can be a (solid-state) hard drive, or a USB drive, or a (digital) optical disc.

In an example, the one or more machine learning models 704 may be incorporated within the data transformation unit 702, thus forming a single computational unit performing several distinct operations of the computer-implemented method according to the disclosure.

Once the state of the analyte 300 is determined, the result may be outputted or displayed by a data output unit 706, for example, a computer or laptop display or a separate display unit 706.

For identifying a state in a sample of analytes 300 using the one or more machine learning models 704, the acquired MRI images are generated from samples of analytes 300 infused with the non-hyperpolarized isotope label 600, preferably accommodated in the open, 3D sample matrix 200 positioned in a measuring chamber 402 of the microfluidic device 400 or accommodated in a vial, as these samples have the advantage of a higher sensitivity compared to standard techniques. The disclosure needs to identify key patterns in the acquired MRI images that serve as indicators for the presence or occurrence of a state in the analyte 300.

Accordingly, in an example, the machine learning model 704 may include a computer-implemented artificial neural network. In that particular example, the computer processing unit 700 furthermore includes a training unit, that may be configured to train the computer-implemented artificial neural network 704 with sequences of NMR signals overtime characterizing a training sequence of NMR signals over time with a known state of an analyte contacted with a non-hyperpolarized isotope label (this concerns the training data); and to apply to the computer-implemented artificial neural network sequences of input signals characterizing at least a test sequence of NMR signals over time with an unknown state of an analyte contacted with a non-hyperpolarized isotope label; and to analyse each applied test sequence of NMR signals over time to generate a predicted state of an analyte contacted with a non-hyperpolarized isotope label for each test sequence of NMR signals over time.

In order to assist the training of the computer-implemented artificial neural network 704 NMR/MRI images will first be annotated or labelled by experts. These annotations or labels in these NMR/MRI images will indicate key patterns that correspond to external stimuli responses (such as drugs) to the cells/organs/analytes 300 under question. These labelled key patterns characterize a training sequence of signals with a known state of an analyte 300 under question with the non-hyperpolarized isotope label 600.

In an example, these annotations or labels can be colours in the images corresponding to signal intensity, which signal intensity, in turn, points to a certain disease stage, hence pointing to a known state of the analyte 300 under question correlating with its infusion with the non-hyperpolarized isotope label 600.

After collecting a statistically significant data cohort of a sufficient amount of such labelled key patterns, the computer-implemented artificial neural network 704 will be trained on these training set of sequence of signals over time and subsequently tested on a validation or test set of sequence of signals over time with an unknown state of an analyte infused with the non-hyperpolarized isotope label 600. Once the model of the artificial neural network 704 achieves acceptable accuracy, it should be able to automatically indicate key patterns, such as signal intensity in NMR/MRI images, in a new, fresh set of NMR/MRI images and convert them into a data format that can be incorporated into the ongoing data processing, thereby adding additional parameters to improve the quality of the final output.

Accordingly, the artificial neural network 704 is able to detect a disease stage (the state of an analyte to be analysed) if the metabolic changes in the NMR/MRI images correlate with such trained disease stage (e.g., the signal intensity).

One technical effect of the system 100 combining the microfluidic device 400 and the NMR apparatus 500 may be the ability to emulate organs' responses—either from an animal or human origin—to external stimuli under in-vitro conditions. The more precise the emulation, the higher the value of the outcome. The sheer complexity of inputs involved in creating precise emulations and the distinctive nature of the test conditions calls for advanced techniques, requiring the implementation of a computer processing unit 700 utilizing one or more computer-implemented artificial neural networks 704.

In terms of implementation, the artificial neural network 704 will be trained with every piece of data from the raw materials used to the process's flow, including all process parameters. The resulting hardware and the analytical outputs may be compared with actual responses to the same external stimuli in in-vitro conditions for both animals and human beings. Based on the outcome of the comparisons on the statistically significant cohort of data, the artificial neural network 704 will be able to determine which parameters contribute to a closer emulation of cells/organs/analytes 300.

The computer-implemented artificial neural network 704 may be able to predict the parameters needed to emulate the cells/organs/analytes 300 actual conditions under question for in-vitro tests. Besides this, getting a better understanding of key parameters will help us build efficient models of various other organs, which are otherwise complex to build.

Accordingly, by comparing the data obtained from cells/organs/analytes 300 using the system according to the disclosure, the microfluidic device 400 accommodating one or more sample matrices 200 with analytes 300, and the NMR apparatus 500, for in-vitro and in-vivo conditions, implementing an artificial neural network 704 will help bridge the translational gap that is otherwise almost impossible to establish using current techniques.

The measuring chambers 402 of the multiple microfluidic elements 450 of the microfluidic device 400 allow for testing multiple responses of cells/organs/analytes 300 to the same external stimuli, that is, the same non-hyperpolarized isotope label 600 and the same magnetic field gradients in, and applied set(s) of radiofrequency pulses in the target area 502 to the detection complex. The objective may be to understand the impact of the external stimuli on other cells/organs/analytes, besides the principal cell/organ/analyte 300 under investigation. Given the complexity of underlying biological processes, advanced methods like artificial intelligence are highly beneficial in understanding the correlation of responses among various cells/organs/analytes and eventually predicting the correlations and thereby responses.

In terms of implementation, the computer-implemented artificial neural network model 704 may be trained with primary and secondary organs' responses to the external stimuli. After training on statistically significant cohort of data, the computer-implemented artificial neural network model 704 may predict the responses of secondary organs to the same external stimuli (in particular, the non-hyperpolarized isotope label 600 being used) that are being tested on the primary organ. These outcomes will help researchers understand the underlying biological mechanisms that are causing these effects and help narrow down the focus.

With this system 100, a versatile platform is created, capable of acquisition and analysis of metabolic data pertaining to a state of an analyte using magnetic resonance techniques in a non-invasive manner. With this platform, the development of more-advanced functional person-specific drug testing systems can be achieved.

For reasons of completeness, various aspects of the present disclosure are set out in the following numbered clauses:

1. A system comprising:
a microfluidic device with a substrate comprising:
   one or more inlet channels;
   a sample matrix comprising an analyte;
   a measuring chamber, wherein the one or more inlet channels are fluidically connected to the measuring chamber, wherein the measuring chamber is configured to receive the sample matrix comprising the analyte; and
   an outlet channel fluidically connected to the measuring chamber;
a non-hyperpolarized isotope label to be introduced in the inlet channel so that the non-hyperpolarized isotope label is contacted with the analyte of the sample matrix to form a detection complex; and
an apparatus to obtain a signal of the detection complex.

2. The system according to clause 1, wherein the apparatus to obtain the signal of the detection complex is an NMR apparatus or a PET apparatus.

3. The system according to clause 1 or 2, comprising:
a processing unit for determining a state of the analyte based on the obtained signal or a sequence of the obtained signal of the detection complex.

4. The system according to clause 1 or 2, wherein the apparatus to obtain the signal of the detection complex is a NMR apparatus, the system comprising:
a processing unit for determining a state of the analyte based on the obtained signal or a sequence of the obtained signal of the detection complex.

5. The system according to any of clauses 1 to 4, wherein the sample matrix is a three-dimensional construct comprising open pores; and wherein the three-dimensional construct is a gel comprising sodium carboxymethyl cellulose.

6. The system according to any of clauses 1 to 5, wherein the gel comprises between 0.5 and 5 wt % of sodium carboxymethyl cellulose.

7. The system according to any of clauses 1 to 4, wherein the sample matrix is a three-dimensional construct; and wherein the three-dimensional construct is selected from at least one of the following: a ceramic construct, a polymer construct, a metal and/or alloy construct, or a composite construct.

8. The system according to any of clauses 1 to 7, the one or more inlet channels comprising:
a non-hyperpolarized isotope label inlet channel for introducing the non-hyperpolarized isotope label, the non-hyperpolarized isotope label inlet channel fluidically connected to the measuring chamber; and
a matrix perfusion inlet channel for introducing a matrix perfusion medium, the matrix perfusion inlet channel fluidically connected to the measuring chamber.

9. The system according to any of clauses 1 to 8, the outlet channel comprising:
a measuring chamber outlet channel fluidically connected to the measuring chamber.

10. The system according to clause 9, the microfluidic device further comprising:
a microfluidic outlet channel fluidically connected to a reservoir, the reservoir fluidically connected to the measuring chamber outlet channel.

11. The system according to clauses 9 and 10, wherein the non-hyperpolarized isotope label inlet channel is above the matrix perfusion inlet channel with respect to a bottom wall of the measuring chamber.

12. The system according to clause 11, wherein the measuring chamber outlet channel is below the non-hyperpolarized isotope label inlet channel and above the matrix perfusion inlet channel with respect to the bottom wall of the measuring chamber.

13. The system according to clause 11 or 12, wherein the matrix perfusion inlet channel is positioned at the bottom wall of the measuring chamber.

14. The system according to any of clauses 1 to 13, wherein the microfluidic device comprises a temperature control unit for maintaining at least the detection complex at body temperature.

15. The system according to any of clauses 2 to 14,
wherein the apparatus to obtain the signal of the detection complex is a NMR apparatus,
wherein the processing unit determines the state of the analyte based on the sequence of the obtained NMR signal of the detection complex by using a machine learning model,
wherein the machine learning model is a computer-implemented artificial neural network;
the processing unit comprises a training unit configured to train the computer-implemented artificial neural network with sequences of NMR signals over time characterizing a training sequence of NMR signals over time with a known state of an analyte contacted with an non-hyperpolarized isotope label, and to apply to the computer-implemented artificial neural network sequences of input signals characterizing at least a test sequence of NMR signals over time with an unknown state of an analyte contacted with an non-hyperpolarized isotope label; and to analyze each applied test sequence of NMR signals over time to generate a predicted state of an analyte contacted with a non-hyperpolarized isotope label for each test sequence of NMR signals over time.

16. The use of the system according to any of clauses 1 to 15 to perform nuclear magnetic resonance analysis based on the obtained signal of the detection complex.

17. A method for obtaining a signal of a detection complex using a sample matrix, the method comprising:
providing a microfluidic device with a substrate comprising:
   one or more inlet channels;
   the sample matrix comprising an analyte;
   a measuring chamber, wherein the one or more inlet channels are fluidically connected to the measuring chamber, wherein the measuring chamber is configured to receive the sample matrix comprising the analyte; and
   an outlet channel fluidically connected to the measuring chamber;
introducing a non-hyperpolarized isotope label in the inlet channel so that the non-hyperpolarized isotope label is contacted with the analyte of the sample matrix to form a detection complex.

18. The method according to clause 17, wherein the obtaining the signal of the detection complex comprises:
applying one or more magnetic field gradients to the detection complex using a magnet unit and a magnetic gradient unit of the NMR apparatus;
applying one or more sets of radiofrequency pulses to the detection complex using a radiofrequency pulse generation unit of the NMR apparatus; and
obtaining from a radiofrequency receiving unit of the NMR apparatus a sequence of NMR signals over time in response to the one or more sets of radiofrequency pulses.

19. The method according to clause 17 or 18, the method comprising determining a state of the analyte based on the obtained signal or a sequence of the obtained signal of the detection complex.

20. The method according to clause 19,
wherein the obtained signal of the detection complex is an obtained NMR signal of the detection complex,
wherein the determining the state of the analyte based on the sequence of the obtained NMR signal of the detection complex comprises:
generating one or multiple time-frequency representations of the sequence of the NMR signal by time-frequency transformation; and
analyzing the time-frequency representations using one or more machine learning models for determining the state of the analyte.

21. The method according to clause 20, wherein the time-frequency transformation of the generating one or multiple time-frequency representations of the sequence of NMR signals is selected from at least one of the following: Fourier transform.

22. The method according to clause 20 or 21, wherein the one or more machine learning models are selected from at least one of the following: an artificial neural network, a decision tree, a regression model, a k-nearest neighbor model, a partial least squares model, a support vector machine, or any combination thereof.

23. The method according to any of clauses 20 to 22, wherein the machine learning model is a computer-implemented artificial neural network, the method further comprising:
training the computer-implemented artificial neural network with sequences of NMR signals over time characterizing a training sequence of NMR signals over time with a known state of an analyte contacted with a non-hyperpolarized isotope label;
applying to the computer-implemented artificial neural network sequences of input signals characterizing at least a test sequence of NMR signals over time with an unknown state of an analyte contacted with a non-hyperpolarized isotope label;
analyzing each applied test sequence of NMR signals over time to generate a predicted state of an analyte contacted with a non-hyperpolarized isotope label for each test sequence of NMR signals over time.

24. The method according to any of clauses 18 to 23, the method comprising:
maintaining the detection complex at a body temperature prior to the applying the one or more magnetic field gradients to the detection complex using a magnet unit and a magnetic gradient unit of the NMR apparatus.

25. A computer-implemented method of determining a state of an analyte, comprising:
receiving an input dataset comprising a sequence of an NMR signal of a detection complex;
producing one or multiple time-frequency representations of the sequence of the NMR signal by time-frequency transformation;
analyzing the time-frequency representations using one or more machine learning model for determining a state of the analyte; and
producing an output dataset comprising a predicted state of the analyte for each test sequence of NMR signals over time.

26. A data processing apparatus comprising apparatus for carrying out the method of clause 25.

27. A computer program comprising instructions which, when the program is executed by a computer, cause the computer to carry out the method of clause 25.

28. A computer-readable medium comprising instructions which, when executed by a computer, cause the computer to carry out the method of clause 25.

1. A system comprising:
a microfluidic device with a substrate comprising:
one or more inlet channels;
a sample matrix comprising an analyte;
a measuring chamber, the one or more inlet channels being fluidically connected to the measuring chamber, the measuring chamber being configured to receive the sample matrix comprising the analyte; and
an outlet channel fluidically connected to the measuring chamber;
a non-hyperpolarized isotope label to be introduced in the measuring chamber through one of the one or more inlet channels so that the non-hyperpolarized isotope label is contacted with the analyte of the sample matrix to form a detection complex; and
an apparatus to obtain a signal of the detection complex.

2. The system according to claim 1, the apparatus to obtain the signal of the detection complex being an NMR apparatus or a PET apparatus.

3. The system according to claim 1, comprising:
a processing unit for determining a state of the analyte based on the obtained signal of the detection complex.

4. The system according to claim 1, the sample matrix being a three-dimensional construct comprising open pores; and the three-dimensional construct being a gel comprising sodium carboxymethyl cellulose.

5. The system according to claim 4, the gel comprising between 0.5 and 5 wt % of sodium carboxymethyl cellulose.

6. The system according to claim 1, the sample matrix being a three-dimensional construct; and the three-dimensional construct being selected from at least one of the following: a ceramic construct, a polymer construct, a metal and/or alloy construct, or a composite construct.

7. The system according to claim 1, the one or more inlet channels comprising:
a non-hyperpolarized isotope label inlet channel for introducing the non-hyperpolarized isotope label, the non-hyperpolarized isotope label inlet channel fluidically connected to the measuring chamber; and
a matrix perfusion inlet channel for introducing a matrix perfusion medium, the matrix perfusion inlet channel fluidically connected to the measuring chamber.

8. The system according to claim 7,
the outlet channel comprising a measuring chamber outlet channel fluidically connected to the measuring chamber; and
the non-hyperpolarized isotope label inlet channel being above the matrix perfusion inlet channel with respect to a bottom wall of the measuring chamber.

9. The system according to claim 8, the measuring chamber outlet channel being below the non-hyperpolarized isotope label inlet channel and above the matrix perfusion inlet channel with respect to the bottom wall of the measuring chamber.

10. The system according to claim 3,
the apparatus to obtain the signal of the detection complex being an NMR apparatus,
the processing unit determining the state of the analyte based on the obtained NMR signal of the detection complex by using a machine learning model,
the machine learning model being a computer-implemented artificial neural network;
the processing unit comprises a training unit configured to train the computer-implemented artificial neural network with sequences of NMR signals over time characterizing a training sequence of NMR signals over time with a known state of an analyte contacted with a non-hyperpolarized isotope label, and to apply to the computer-implemented artificial neural network sequences of input signals characterizing at least a test sequence of NMR signals over time with an unknown state of an analyte contacted with a non-hyperpolarized isotope label; and to analyze each applied test sequence of NMR signals over time to generate a predicted state of an analyte contacted with a non-hyperpolarized isotope label for each test sequence of NMR signals over time.

11. A method for obtaining a signal of a detection complex using a sample matrix, the method comprising:
providing a microfluidic device with a substrate comprising:
one or more inlet channels;
the sample matrix comprising an analyte;
a measuring chamber, the one or more inlet channels being fluidically connected to the measuring chamber, the measuring chamber being configured to receive the sample matrix comprising the analyte; and
an outlet channel fluidically connected to the measuring chamber;
introducing a non-hyperpolarized isotope label in the measuring chamber through one of the one or more inlet channels so that the non-hyperpolarized isotope label is contacted with the analyte of the sample matrix to form a detection complex.

12. The method according to claim 11, the obtaining the signal of the detection complex comprising:
applying one or more magnetic field gradients to the detection complex using a magnet unit and a magnetic gradient unit of an NMR apparatus;
applying one or more sets of radiofrequency pulses to the detection complex using a radiofrequency pulse generation unit of the NMR apparatus; and
obtaining from a radiofrequency receiving unit of the NMR apparatus a sequence of NMR signals over time in response to the one or more sets of radiofrequency pulses.

13. The method according to claim 11, the method comprising determining a state of the analyte based on the obtained signal of the detection complex.

14. The method according to claim 13,
the obtained signal of the detection complex being an obtained NMR signal of the detection complex,
the determining the state of the analyte based on the sequence of the obtained NMR signal of the detection complex comprising:
generating one or multiple time-frequency representations of the sequence of the NMR signal by time-frequency transformation; and
analyzing the time-frequency representations using one or more machine learning models for determining a state of the analyte.

15. The method according to claim 14, the machine learning model being a computer-implemented artificial neural network, the method further comprising:
training the computer-implemented artificial neural network with sequences of NMR signals over time characterizing a training sequence of NMR signals over time with a known state of an analyte contacted with a non-hyperpolarized isotope label;
applying to the computer-implemented artificial neural network sequences of input signals characterizing at least a test sequence of NMR signals over time with an unknown state of an analyte contacted with a non-hyperpolarized isotope label; and
analyzing each applied test sequence of NMR signals over time to generate a predicted state of an analyte contacted with a non-hyperpolarized isotope label for each test sequence of NMR signals over time.
